(19) United States
(12) Patent Application Publication
(10) Pub. No.: US 2013/0195726 A1
(43) Pub. Date: Aug. 1, 2013

(54) MICROWAVE AND RADIO FREQUENCY MATERIAL PROCESSING

(71) Applicant: Philip Joseph Norton, Birkdale (AU)

(72) Inventor: Philip Joseph Norton, Birkdale (AU)

(73) Assignee: QUANTUM WAVE PTY LTD, Birkdale, Queensland (AU)

(21) Appl. No.: 13/695,242

(22) PCT Filed: Apr. 27, 2011
(86) PCT No.: PCT/AU2011/000475

§ 371 Date: Nov. 26, 2012

(30) Foreign Application Priority Data
Apr. 30, 2010 (AU) 2010901833

(51) Int. Cl. B01J 19/12

(52) U.S. Cl. CPC B01J 19/126
USPC 422/119; 422/186.29

(57) ABSTRACT

An apparatus for processing of material, the apparatus comprising: a compartment for accommodating said material during processing, said compartment having at least one wall, an inlet for receiving the material to be processed and an outlet for material once processed to exit the compartment; and a radiation source for directing electromagnetic radiation into the compartment through a portion of the compartment wall that is at least partially transparent to the radiation, the radiation being microwave or radio frequency (RF) electromagnetic radiation; wherein the apparatus is configured to place at least some of the material in the compartment in contact with the at least partially transparent portion of the compartment wall through which the radiation is admitted to the compartment.

### FIELD OF THE INVENTION

The present invention relates to an apparatus and system for microwave and/or radio frequency (RF) processing of material.

### BACKGROUND OF THE INVENTION

Microwaves are electromagnetic waves in the segment of the electromagnetic spectrum with frequencies between 300 MHz and 300 GHz. This includes bands commonly referred to as Ultra High Frequency (UHF), Super High Frequency (SHF) and Extremely High Frequency (EHF). It has been thought that microwaves together with the Very High Frequency (VHF) band of the radio frequency (RF) spectrum (30-300 MHz) may be usefully employed to process various materials. Without wishing to be bound by theory, it is understood that microwaves and/or VHF (RF) waves are absorbed by materials based on the materials' dielectric properties. Some materials may reflect, be transparent or slow to absorb microwave and/or RF energy. Due to differences in the dielectric properties of each particular molecule in a material bulk, some molecules absorb microwave energy at a greater rate and can thus be at a much higher temperature than the surrounding material. This enables chemical and physical reactions to occur at lower bulk temperatures than would normally be required under conventional pyrometallurgical processing.

Attempts have been made to process materials such as minerals with microwaves using equipment such as microwave batch applicators, fluidised beds and rotary kilns. However, all of these previous attempts have encountered a number of problems which has meant that no microwave process for processing materials such as minerals has found commercial acceptance. A particular problem is the formation and control of plasmas. Plasmas are ionised gas particles which increase in intensity as the temperature and/or microwave power density increases. The plasmas provide localised regions of extremely high temperatures and have been found to result in damage to generator magnetrons, burnt and cracked microwave windows and furthermore have absorbed energy preferentially to the material being processed.

### SUMMARY OF THE INVENTION

According to an embodiment of the present invention, there is provided an apparatus for processing of material, the apparatus comprising:
a compartment for accommodating said material during processing, said compartment having at least one wall, an inlet for receiving the material to be processed and an outlet for material once processed to exit the compartment; and
a radiation source for emitting electromagnetic radiation into the compartment through a portion of the compartment wall that is at least partially transparent to the radiation, the radiation being microwave or radio frequency (RF) electromagnetic radiation (or both);
wherein the apparatus is configured to place at least some of the material in the compartment in contact with the at least partially transparent portion of the compartment wall through which the radiation is admitted to the compartment.

According to a further embodiment of the present invention, there is provided an apparatus for processing of material, the apparatus comprising:
a compartment for accommodating said material during processing, said compartment having at least one wall, an inlet for receiving the material to be processed and an outlet for the material once processed to exit the compartment; and
a transmission assembly for transmitting microwave or RF electromagnetic radiation (or both) to an interior zone adjacent to the compartment wall,
wherein the apparatus is configured such that during operation at least some of the material in the interior zone is in contact with the compartment wall and thereby provides a non-gaseous medium through which the radiation travels upon entry to the interior zone.

Throughout the specification references to microwave electromagnetic radiation is understood to mean electromagnetic radiation having a frequency of between 300 MHz and 300 GHz.

Throughout the specification references to radio frequency electromagnetic radiation is understood to mean electromagnetic radiation having a frequency of between 30 MHz and 300 MHz.

The radiation source may be the outlet of a waveguide which couples to a radiation generator. In another embodiment, the radiation source may be a space between a radiation generator and the compartment wall.

The radiation source may comprise a transmission assembly for transmitting the electromagnetic radiation into the compartment.

The apparatus may also comprise at least one radiation generator for generating microwave and/or RF electromagnetic radiation, the transmission assembly being configured to transmit the radiation generated by each generator to the compartment.

The transmission assembly may comprise a waveguide.

The waveguide may have an outlet adjacent to the compartment wall.

The compartment may have a single cylindrical wall.

The compartment may be fixed during operation.

In another arrangement, the compartment or a part of the compartment may be configured to rotate, preferably about a central longitudinal axis.

When the compartment (or part thereof) is configured to rotate, the radiation source is fixed.

The apparatus may comprise a casing around the compartment.

The casing may extend between the compartment and the transmission assembly outlet but preferably, the transmission assembly extends through the casing.

The casing may be fixed during operation of the apparatus and the compartment (or a part thereof) configured to rotate within the casing.

The apparatus may also comprise a mechanism for causing the material to travel in a spiral flow path relative to the direction of the electromagnetic radiation admitted into the compartment from the radiation source as the material travels between the inlet and the outlet.

The spiralling mechanism may comprise a rotating screw located inside the compartment.

The axis of the rotating screw may be coaxial with the longitudinal axis of the compartment.

The flights of the screw may extend between the longitudinal inner surfaces of the compartment.

The compartment may be configured to extend substantially horizontally.

The compartment may be configured to extend substantially vertically.

The apparatus may be configured so that the operating height of the material in the compartment is above the portion of the compartment wall through which the electromagnetic radiation is admitted.

The inlet and the outlet of the compartment may define a general direction of flow of the material through the compartment including past the portion of the compartment wall through which the electromagnetic radiation is admitted, this general direction of flow typically corresponding to the longitudinal direction of the compartment. The apparatus may be configured so that the electromagnetic radiation is admitted to the compartment transverse (which may be approximately 90°) to this general direction of flow.

The apparatus may comprise a gas outlet for gas to exit the compartment.

The gas outlet is preferably located above the operating height of the material.

The waveguide may be split into a plurality of waveguide paths. In this embodiment, the waveguide outlet is also split into a plurality of waveguide path outlets.

The apparatus may be of TE10 dominant mode design.

The waveguide may be a TE10 mode waveguide.

The compartment may be of substantially the same width as the waveguide, preferably so that the compartment is TE10 mode dominant.

The transmission assembly may comprise a second waveguide cross-coupled to the compartment with respect to the first mentioned waveguide.

The transmission assembly may comprise a waveguide window for protecting the radiation generator from plasmas.

The transmission assembly may comprise a waveguide window shielder configured to blow a layer of gas over the surface of the window.

The transmission assembly may comprise a plasma extinguishing system for extinguishing plasmas close to the waveguide window.

The plasma extinguishing system may comprise one or more gas inlets configured to blow gas into the waveguide to extinguish any plasmas.

The apparatus may comprise a plurality of temperature sensors located along the length of the compartment.

The apparatus may comprise a first temperature sensor capable of sensing the temperature in an internal portion of the compartment and a second temperature sensor capable of sensing the temperature near the inner surface of the compartment wall.

The first temperature sensor is preferably located in the internal portion of the compartment.

Each temperature sensor, in particular the first temperature sensor, may be provided with a microwave or RF electromagnetic radiation reflective sheath which may be earthed.

The apparatus may also comprise a scraper for scraping material off the inner surface of the compartment wall.

The scraper comprises a rod sitting against the inner surface of the compartment wall.

The scraper may extend substantially the length of the compartment.

Embodiments of the present invention also provide a system for processing of material, the system comprising at least two apparatuses for processing of material as described in any one of the embodiments above.

According to another embodiment of the present invention, there is provided a method of processing material, the method comprising:
receiving the material to be processed in a compartment through an inlet of the compartment, the compartment having at least one wall;
emitting electromagnetic radiation from a radiation source into the compartment through a portion of the compartment wall which is at least partially transparent to radiation, the radiation being microwave or radio frequency (RF) electromagnetic radiation (or both);
contacting at least some of the material to be processed with the portion of the compartment wall through which radiation is admitted into the compartment, prior to admitting the radiation into the compartment; and
outputting the material once processed through an outlet of the compartment.

### BRIEF DESCRIPTION OF THE DRAWINGS

Embodiments of the present invention will now be described, by way of example only, with reference to the accompanying drawings, in which:

FIG. 1 is a block diagram of a system for continuous microwave and/or RF wave processing of material according to an embodiment of the present invention;

FIG. 2 is a schematic view of first and second apparatuses for continuous microwave and/or RF wave processing of material, connected in series, the first and second apparatuses being of different embodiments of the present invention;

FIG. 3 is a schematic view of the first apparatus of FIG. 2;

FIG. 4 is a schematic view of the second apparatus of FIG. 2;

FIG. 5 is a schematic view of a variation of the second apparatus of FIG. 2;

FIG. 6 is a schematic view of another variation of the second apparatus of FIG. 2;

FIG. 7 is a top view of the second apparatus of FIG. 4;

FIG. 8 is a schematic view of a microwave choke used in the first or second apparatus; and

FIG. 9 is a schematic view of a waveguide window with a plasma extinguishing system used in the first or second apparatus.

### DETAILED DESCRIPTION OF THE EMBODIMENTS

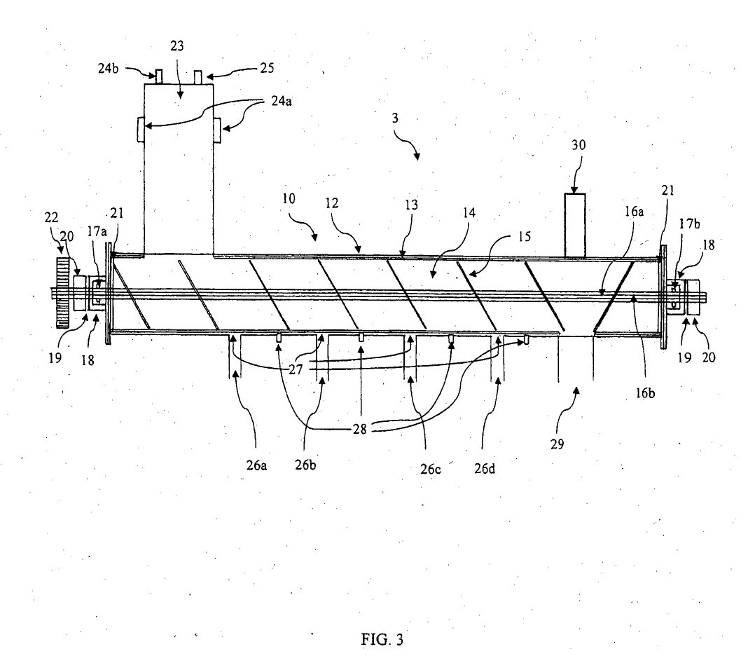

Referring firstly to FIG. 3, a first apparatus 10 for continuous microwave and/or radio frequency (RF) wave processing of material according to an embodiment of the present invention is shown. The apparatus 10 comprises a compartment 3 in the form of a cylindrical tube 13 or a plurality of cylindrical tubes joined together to form a single tube.

The compartment accommodates the material as it is being processed and is defined by a cylindrical wall. The apparatus 10 also has a casing around the compartment 3 in the form of a cylindrical outer housing 12. The outer housing 12 is formed of an electrically conducting material which reflects microwaves and RF waves so as to restrict leakage of electromagnetic radiation from the apparatus 10. A typical material from which the outer housing 12 is formed is metal, preferably stainless steel for its temperature and chemically inert properties. The inner tube 13 is formed of a material which is transparent or semi-transparent to microwave and RF waves, preferably thermally insulating and of high temperature resistance and high thermal shock resistance. Typically, the inner tube 13 is formed from alumina, mullite, quartz, sialon, boron nitride or any other ceramic which is microwave transparent with thermal conductivity in the range of 0.005 W/m-K to 300 W/m-K.

By thermally insulating the walls of the compartment 3 through the construction of the thermally insulating inner tube 13, convection and/or radiation or process heat is kept to a minimum within the apparatus. This means that the internal gases in the apparatus 10 are kept to a minimum temperature. This aids in the minimisation of plasma formation and the reduction in intensity of those plasmas that are formed.

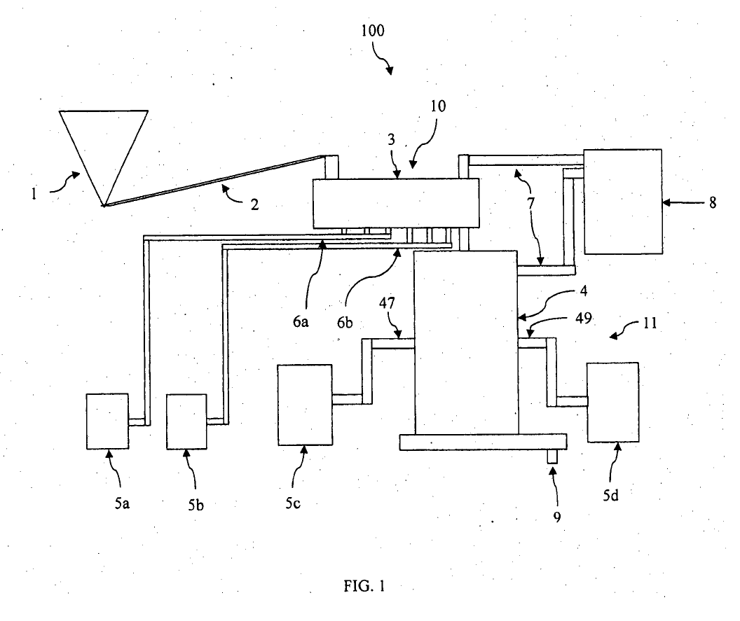

The compartment has an inlet 23 at one end through which material is fed continuously to the compartment from a feed hopper (item 1 in FIG. 1). Gamma level sensors 24a and/or a level indicator 24b located on the inlet feed hopper 23 monitor and provide the correct material height level within the feed hopper. The sensors 24a,b are connected to a Programmable Logic Controller (PLC) to automatically control the flow and volume of material from the feed hopper 1 to the compartment inlet 23 via a conveyor 2. Additional sensors 25 are provided close to the inlet 23 to detect microwave or RF radiation near the inlet 23 to monitor for leakage of electromagnetic radiation through the inlet 23. The compartment 3 also has a processed material outlet 29 located at the opposite end of the compartment to the inlet 23 for processed material to exit the compartment. A general direction of flow of material through the compartment 3 is thus defined from the inlet 23 to the outlet 29. A gas outlet 30 is provided at the same end of the compartment as the processed material outlet 29 (but spaced vertically above the material outlet 29) for gases to exit the compartment 3. These gases may include gases produced in the processing of the material and/or process gases introduced to the compartment 3 via the inlet 23. Depending on the application, the process gases may be air, an inert gas, a reductant, for oxidation, for a chemical reaction(s), as a flushing gas or to semi-fluidise the material being processed. The gases may be collected and treated elsewhere by a suitable mechanism to recover useful product and/or to safely dispose.

The apparatus 10 also comprises at least one microwave and/or RF radiation generator 5 (shown in FIG. 1) which generates electromagnetic radiation that is emitted into the compartment 3 through a portion of the compartment wall via a transmission assembly incorporating a waveguide 26. Material passes through an interior zone of the compartment as it moves between the inlet and outlet of the compartment during processing. The apparatus 10 is configured such that at least some of the material is placed in contact with the compartment wall. Thus, as the electromagnetic radiation enters the compartment, it is admitted into the material, that is it passes through a non-gaseous medium. This configuration reduces the formation and intensity of plasmas as well as improving the operational efficiency of the apparatus because the radiation is absorbed into the material being processed.

The radiation generator 5 may be a constant wave (CW) magnetron, a pulsed magnetron, a power grid tube, a klystron, a klystrode, a crossed-field amplifier, a travelling wave tube, a gyrotron and a RF generator.

The waveguide 26, preferably being a standard TE10 mode rectangular waveguide, has an outlet adjacent to a portion of the compartment's wall defined by the inner tube 13 so that electromagnetic radiation enters the compartment through this portion.

The waveguide outlet may be horned outlets for high frequencies. The wave guide outlet may also consist of a slotted wave guide constructed parallel to the outer housing 12 with electromagnetic radiation being emitted into the compartment from each slot of the slotted wave guide. The diameter of compartment 3 is designed to suit the particular frequency, penetration depth and dielectric properties of the process material so that the maximum amount of electromagnetic radiation is absorbed by the process material and the minimal amount of electromagnetic radiation reaches the gas space above the material being processed.

The waveguide may be a single wave guide or preferably the wave guide is split into a plurality of waveguide paths 26a, 26b, 26c and 26d. The waveguide paths 26a, 26b, 26c and 26d each have an outlet 27 adjacent to the compartment inner tube 13 which transmits electromagnetic radiation into an interior zone of the compartment. The waveguide paths extend through portions of the outer metal housing 12 of the compartment 3. From the waveguide outlets 27, the microwaves and/or RF waves can readily pass through portions of the microwave transparent inner tube 13 to enter the compartment. The waveguide paths 26a, 26b, 26c, and 26d are provided along the bottom of the compartment 3. The waveguide 26 is thus configured to emit the electromagnetic radiation into the compartment transverse to the general direction of flow of the material through the compartment from the inlet to the outlet. This configuration enables the electromagnetic radiation to pass through a non-gaseous medium as it admitted into the compartment. Furthermore, it means that the microwave and/or RF electromagnetic radiation is directed at a large surface area of the material in the compartment relative to the volume. This maximises the amount of energy which is absorbed directly into the material being processed, rather than ionizing the internal gases in the compartment 3. As a result, the formation of plasmas is further minimised.

By splitting the waveguide into a plurality of waveguide paths, a single radiation generator can be used to provide different power densities to match power requirements to the material being processed at specific locations along the compartment. To do this the waveguide paths are designed with different heights but preferably the height being less than half a wave length to minimise the formation of unwanted modes, (but the same widths so as to not affect the TE10 mode of the waveguide). Waveguide paths of greater heights decrease the power density of the electromagnetic radiation being transmitted to the material.

It is known that a material's dielectric properties change as temperatures rise due to material phase changes, especially near the transition temperatures. This can lead to one known difficulty in operating apparatuses and systems for microwave processing material—“thermal runaway”. Thermal runaway is an uncontrolled rise in temperature and is a particular problem at a material's transition temperature. By designing the waveguide paths to provide electromagnetic radiation of different power densities along the length of the compartment in which the material is being processed, thermal runaway can be better avoided by providing the appropriate energy inputs to sustain and maintain a gradual increase in the temperature gradient along the length of the compartment. Furthermore, where the material being processed is undergoing one or more chemical reactions use of the split waveguide enables the provision of the appropriate power density at specific locations along the length of the compartment given the exothermic or endothermic nature of the chemical reaction(s).

Temperature sensors 28 are provided along the length of the compartment 3 and between the waveguide outlets 27 to enable monitoring of the temperature gradient across the compartment 3. This information from the temperature sensors 28 can thus be used to adjust the height of the waveguide paths and hence the power density of the microwaves and/or RF waves being provided at specific locations along the length of the compartment.

In an alternative arrangement, the apparatus comprises a plurality of radiation generators. A single waveguide, preferably a standard rectangular waveguide is split into a plurality of waveguide paths or a plurality of separate waveguides may be employed to transmit electromagnetic radiation from the plurality of radiation generators into the compartment. In this arrangement the power density of the electromagnetic radiation being provided at specific locations along the length of the compartment can be varied by varying the power output of one or more of the radiation generators.

The material being processed moves continuously through the compartment 3 from the inlet 23 to the outlet 29 including through the interior zone and in contact with the compartment wall along a spiral flow-path relative to the direction of the electromagnetic radiation being emitted into the compartment (which will be described below). The spiral flow-path is created by a spiralling mechanism in the form of a screw conveyor 14 located in the compartment 3. The screw conveyor 14 comprises a central shaft 16a with a screw consisting of a plurality of flights 15 mounted to the shaft. The central shaft 16a of the screw conveyor extends through the centre of the compartment 3 on a parallel axis thereto. The flights 15 of the screw extend between the top and bottom of the inner tube 13 forming the compartment 3. The screw conveyor 14 could be constructed with thin metal flights, but preferably, in order to minimise reflected microwaves and/or RF waves within the compartment 3, the screw conveyor is constructed from a material which is transparent or semi-transparent to microwaves and RF waves. The screw conveyor 14 is also preferably formed from a material of high temperature resistance and high thermal shock resistance. A typical material would be a ceramic such as alumina. The shaft 16a of the screw conveyor is air cooled so that the thermal expansion of the shaft is no greater than the thermal expansion of the ceramic screw. The shaft 16a is supported on high temperature resistant bearings 20 and is driven via a drive gear 22. The screw conveyor 14 is fixed by a key 16b (or other mechanical means) to the shaft 16a.

As the screw 14 rotates, material heaps up in front of the advancing flight and is pushed through the compartment 3. Particles in the heap next to the flight surface are carried part way up the flight surface then flow down the forward moving side of the heap thoroughly mixing the material and providing maximum exposure to the inner surface of the compartment 3 (i.e. the inner tube 13). The curvature and pitch of the flights 15 are designed to provide maximum tumbling action to the material being processed. The aim of this design is to enable the apparatus, during operation, to have a substantially even depth of material between the flights. The design of the screw conveyor 14 providing a spiral flow-path of the material results in generally homogenous microwave and/or RF absorption. This means that the processing operation is more efficient and there is less chance of local regions of very high temperatures or “hot spots” being formed. This has the advantage of minimising the formation of plasmas as well as reducing the chance of the compartment walls being damaged by these “hot spots”.

It is noted that the compartment 3 and hence the screw conveyor 14 inside, may be horizontal or at an angle to the horizontal depending on the consistency and flow of the material being processed.

The compartment 3 is physically, thermally and electromagnetically sealed at each end. The compartment 3 is physically sealed to keep air out and/or to keep any process gas in, is thermally sealed to prevent heat from getting to the bearings and gas seals, and electromagnetically sealed for the safety of preventing microwaves and/or RF waves leaking from the compartment. Thermal insulation plates 21 (which are microwave and RF transparent) are fitted to each end of the compartment 3. Microwave chokes 17a, 17b are located at either end of the compartment 3 and are fitted around the shaft 16a of the screw conveyer 14 which extends through the thermal insulation plates 21. The microwave chokes 17a, 17b are designed in accordance with the particular frequency (or multiple frequencies) of electromagnetic radiation which is used in the apparatus. End caps 18 formed of a semi-conducting material such as silicon carbide are placed over the chokes 17a, 17b to absorb any stray electromagnetic radiation that bypasses the chokes. In an alternative embodiment, where variable frequency microwaves are used in the apparatus, instead of chokes, the apparatus comprises brass or carbon bushes earthing the shaft 16a to the outer housing 12. Gas seals 19 capable of withstanding high temperatures are mounted on the shaft 16a to seal the compartment 3 from any gas leaks.

The design of the first apparatus 10 is such that the material being processed is constantly being moved towards contact with the inner surface of the compartment 3, specifically the inner surface of the inner tube 13, and towards the source of electromagnetic radiation into the compartment. This means that the first apparatus 10 is particularly suitable for processing with high frequency microwaves such as 24.124 GHz, 5.8 GHz and 2.45 GHz. If the diameter of the screw conveyor was over 300 mm then 915 MHz, 460 MHz or RF frequency would be preferable. Penetration depth of the microwaves and/or RF waves varies depending on the material being processed, the temperature of the material and the electromagnetic frequency. The design of the apparatus including the operating electromagnetic frequency must take into account all of these factors. The aforementioned high frequency microwaves have had limited previous commercial application because of their low penetration depths into the material being processed (the higher the microwave frequency, the lower the penetration depth). It is advantageous that the first apparatus can process with these high frequency microwaves because some electrically insulating materials do not couple or heat well at ambient (room) temperature and at low frequencies, but do couple and heat at high temperatures or at higher frequencies. For example pure alumina is transparent at ambient temperature to 915 MHz or 2.45 GHz microwaves but couples at room temperature at 24 to 30 GHz.

High penetration depths occur when materials do not couple or heat well in a microwave field. However, coupling often increases with temperature resulting in a decrease in penetration depth. To overcome the loss in penetration the apparatus may also be operated with dual or multiple frequencies. This involves changing to a lower frequency with a greater penetration depth as the temperature of the material in the compartment increases. For example, as the temperature gradient rises moderate frequencies such as 2.45 GHz begin to couple followed by low frequencies such as 915 MHz coupling at higher temperatures.

The generator may supply microwaves or RF waves continuously or as pulses to the material being processed in the compartment. The first apparatus 10 is particularly suitable for processing material with high power density pulsed microwaves as the material being processed is constantly being moved into the electromagnetic field. High powered pulsed microwaves might be used to micro-fracture particular materials such as ores and vitrified materials.

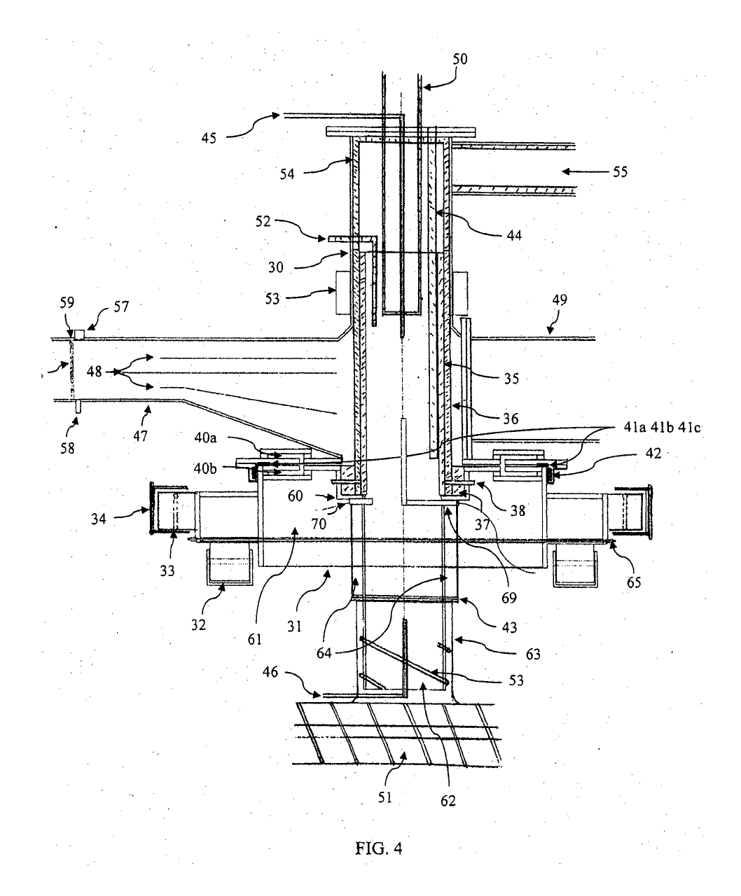

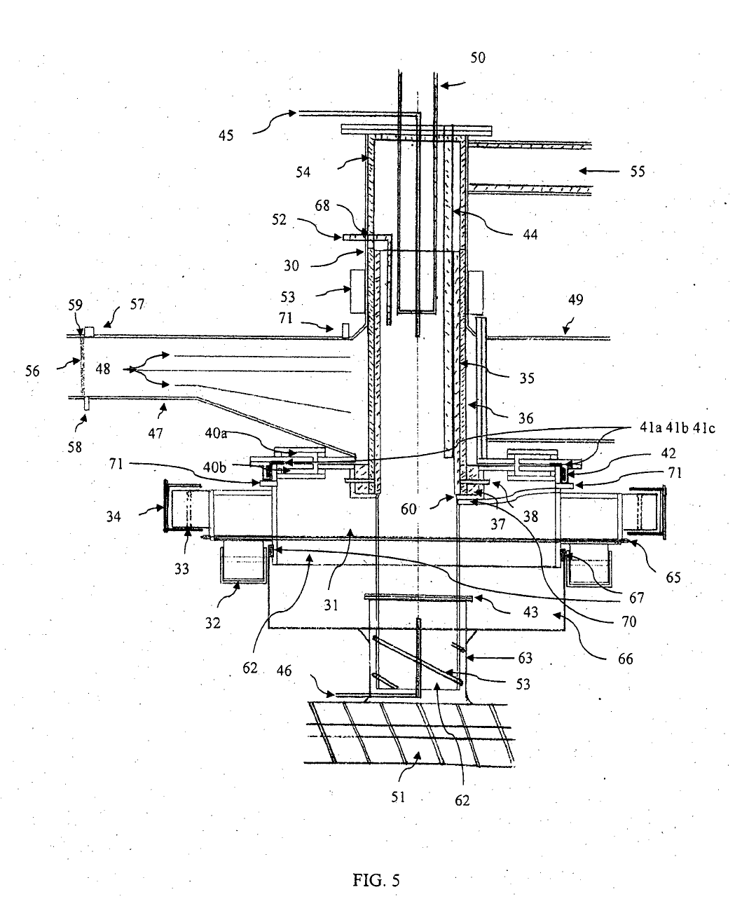

Referring now to FIGS. 4 and 5, a second apparatus 11 for continuous microwave and/or radio frequency (RF) wave processing of material according to an embodiment of the present invention is shown. The second apparatus 11 has a number of similar features to the first apparatus 10 including a split waveguide 47 and a cylindrical compartment 4 defined by a cylindrical wall, and which is thermally insulated. A notable difference between the second and first apparatuses, however, is that the compartment 4 of the second apparatus 4 is configured vertically with an inlet 50 at its top through which material is fed continuously to the compartment and an outlet 60 at its bottom for processed material to exit the compartment. Thus, the material moves through the compartment 4 under gravity along a general direction of flow between the inlet and the outlet.

The material feed to the inlet 50 is controlled by Programmable Logic Controllers (PLC) connected to a mechanical level indicator 52 and/or a gamma level indicator 53 located near the inlet 50. A thermocouple 69 is also positioned inside the compartment 4 and extends up into the centre of the process tube 35 to monitor the internal process temperature at the centre of the tube. A thermocouple 70 is also positioned inside compartment 4 to monitor the temperature of the extremities of the process material adjacent the inner surface of the compartment. The thermocouples are metallic sheathed and earthed to compartment 4. Power, which is reflected from the metallic thermocouple sheath, is absorbed by the surrounding process material and is not reflected back into the waveguide

This configuration of thermocouples advantageously enables the temperature of the process tube to be monitored both at the centre and the edge of compartment. At optimal operating conditions, the temperature distribution across the material in the compartment should be substantially even. By monitoring the temperature gradient between the centre and the edge of the material, operating parameters of the apparatus 11 may be adjusted to even out the temperature distribution across the material. In some instances, this may require replacing the inner tube 35 with a tube of different internal diameter. For example, if the temperature at the centre of the material in the compartment is much lower than the temperature of the material adjacent the inner surface of the compartment, then this may indicate that the internal diameter of the tube is too great given the radiation penetration depth of the particular material being processed and that a narrower tube should be used. The apparatus is designed so that tubes 35 of different internal diameters can be readily incorporated into the apparatus for example by using mountings of adjustable width.

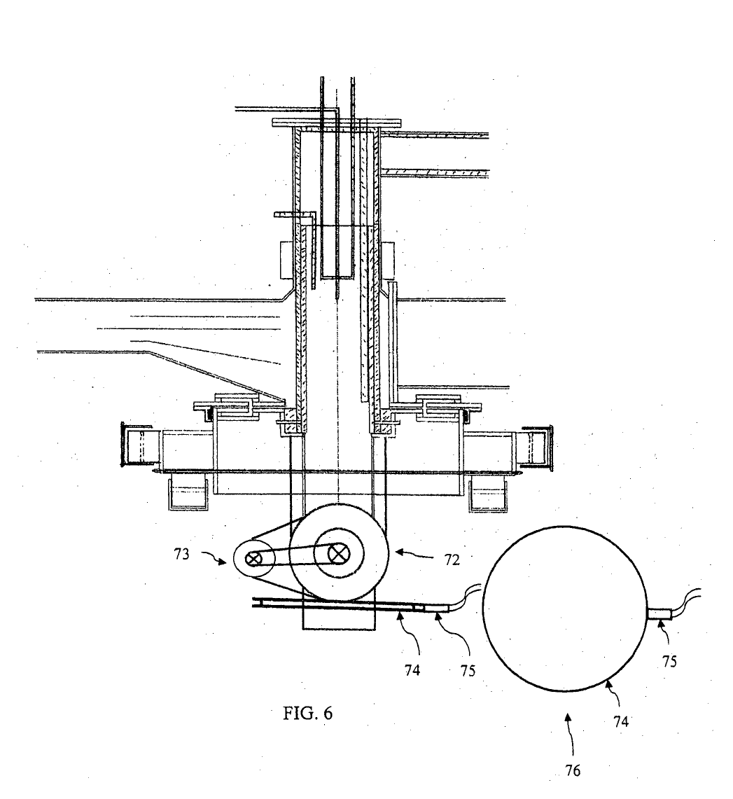

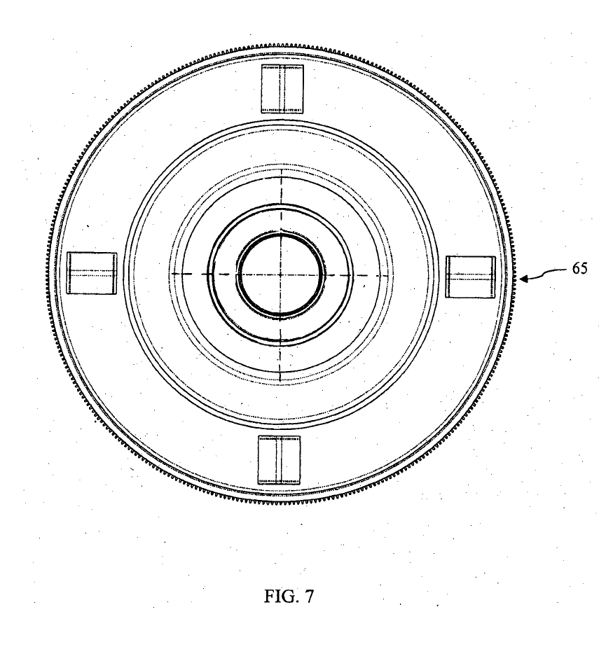

The processed material, after a sufficient residence time, is metered out of the compartment through its outlet 62 by an outlet screw conveyor 51. Screw flights 53 are provided on the external surface of the compartment near its outlet 62 to stop processed material moving up between the compartment outlet 62 and the inlet 64 of the screw conveyor 51. In another embodiment shown in FIG. 6 the material may be metered out of the second apparatus 11 by a high temperature rotary valve.

A gas outlet 55 is provided at the top of the compartment 4 for the gases produced by the processing of the material to exit the compartment. Process gas inlet tubes 45, 46 are located at the top and bottom of the compartment 4 to allow for process gases to be inputted to the compartment 4 if required. Depending on the application, the process gasses may be air, an inert gas, a reductant, an oxidant, for chemical reactions, as a flushing gas or to semi-fluidize the material being processed.

The second apparatus 11 also comprises a microwave and/or RF radiation generator 5 (shown in FIG. 1) which generates electromagnetic radiation that is transmitted into the compartment 4 by a transmission assembly incorporating a waveguide 47 through a portion of the wall of the compartment 4. As with the first apparatus, material passes through an interior zone of the compartment 4 as it moves between the inlet and outlet of the compartment during processing with at least some of the material in the compartment in contact with the compartment wall. Thus, as the electromagnetic radiation is admitted to the compartment through the portion of the compartment wall, it passes through a non-gaseous medium. This configuration reduces the formation and intensity of plasmas as well as improving the operational efficiency of the apparatus because the radiation is absorbed into the material being processed rather than ionising gases in the compartment.

The waveguide 47 is positioned horizontally with respect to the compartment 4 and transverse to the general direction of the flow of the material being processed through the compartment between the inlet and outlet. Thus, the waveguide is configured to transmit the electromagnetic radiation into the compartment transverse to the general direction of flow of the material through the compartment. The waveguide 47 is also configured so that the electromagnetic radiation is transmitted into the compartment 4 below the height of the material in the compartment 4 during operation. That is, the portion of the compartment wall through which radiation is admitted into the compartment is below the operational height of the material in the compartment. The second apparatus 11 is configured so that gases produced by the processing of the material in the compartment 4 escape from the material bulk and exit the compartment through a gas outlet 55 above the height of the material in the compartment and above the portion of the compartment wall through which the waveguide 47 transmits electromagnetic radiation into the compartment 4. These configurations of the waveguide 47 and the gas outlet 55 mean that electromagnetic radiation is transmitted entirely into the material being processed and not to any internal gases in the compartment 4. This results in improved efficiency in the operation of the apparatus 4 as well as minimising plasma formation.

The waveguide can be a single waveguide, preferably a standard TE10 mode rectangular waveguide, but preferably the waveguide is split as described above with respect to the split waveguide of the first apparatus 10. By using a plurality of split wave guide paths 48 a vertical array of TE10 dominant mode patterns can be achieved within the compartment 4.

Microwaves and/or RF waves are transmitted into the compartment 4 by a single waveguide or as in the embodiment shown in FIG. 4 can be cross-coupled by a second waveguide 49. This enables electromagnetic radiation to be transmitted into the compartment from opposing directions, enhancing the efficiency of the process. In the embodiment where the transmission assembly only has a single waveguide, a parabolic metal plate is provided in place of the second waveguide. The parabolic plate reflects waves that may have by-passed the material being processed back towards the centre of the material.

The compartment 4 comprises an upper portion 30 formed of a electrically conductive material which reflects microwaves and RF waves, preferably an electrically conducting material, preferably metal such as stainless steel for its temperature resistance and chemically inert properties. The upper portion is stationary and supported above a lower portion 31 which is configured to rotate in use. The portion of the compartment through which the radiation is admitted into the compartment is located at the lower portion. The interior zone is also located within the lower portion 31. The apparatus 11 has a casing 61 around the lower portion 31 which is held stationary whilst the lower portion 31 rotates inside the casing 61. The casing 61 is formed of a high temperature resistant material, preferably the same as that of the upper portion. The lower portion 31 also has a wide base 62 to provide structural support for the compartment 4 above it. The lower portion 31 rotates about a vertical axis extending through the centre of the compartment 4 and is supported vertically by a thrust bearing or preferably vertical support rollers 32. The vertical alignment of the lower housing is kept in position by horizontal support rollers 33 which are mounted on compression pads 34 to allow for thermal expansion of the compartment 4. Rotation of the lower portion 31 is driven via a drive gear 41 which runs around the base 62 of the lower portion.

The waveguide 47 is fixed and held stationary relative to the rotating lower portion 31, extending through the casing 61 so that the waveguide outlet is adjacent the lower portion. Rotation of the lower portion 31 of the apparatus as the material is fed vertically into the compartment 4 through its fixed inlet 50 causes the material being processed to be spiralled relative to the electromagnetic radiation being transmitted into the compartment as well as to change the portion of the wall of the compartment through which electromagnetic radiation is admitted into the compartment. As the material descends through the compartment 4 under gravity, the rotation of the lower portion 31 moves the material through the higher and lower power density areas of the electromagnetic field. This results in generally homogenous microwave and/or RF absorption. The processing operation is thus more efficient and there is less chance of local regions of very high temperatures or “hot spots” being formed. This in turn further minimises the formation of plasmas.

The lower portion 31 of the compartment 4 comprises an inner tube 35 formed of a material which is high temperature resistant, thermal shock resistant and microwave and/or RF wave transparent. Typically the inner tube is formed of a ceramic, such as quartz, alumina, mullite, sialon, boron nitride or any ceramic which is microwave transparent with thermal conductivity in the range of 0.005 W/m-K to 300 W/m-K. The inner tube 35 is encased by a low density thermal insulation tube 36 such as low density alumina. The thermal expansion of the inner tube 35 at process temperature should match the thermal expansion of the outer tube 36. The inner tube 35 and insulation tube 36 sit on a ledge 60 of the base 61 and are held in position by a ceramic holder 37 and lock pins 38. Thermal expansion of the shell, base, inner tube and ceramic holder are allowed for when machining. The ceramic holder could also be made from a low density ceramic such as low density alumina. The inner tube could also be glued with a ceramic glue to the holder adding to the stability of the inner tube and to stop any vertical movement of the inner tube. As the inner tube expands due to thermal expansion, the low density ceramic holder material compresses allowing for the thermal expansion.

In addition to the insulation tube 36, the internal walls of the compartment 4 in its upper portion 30 is thermally insulated with a microwave and/or RF wave transparent low density thermal insulation layer 54. As discussed above with respect to the first apparatus 10, thermally insulating the compartment in which the material is being processed means that convection and/or radiation of process heat is kept to a minimum within the compartment 4. As a result, plasma formation is minimised and those that are formed are of low intensity.

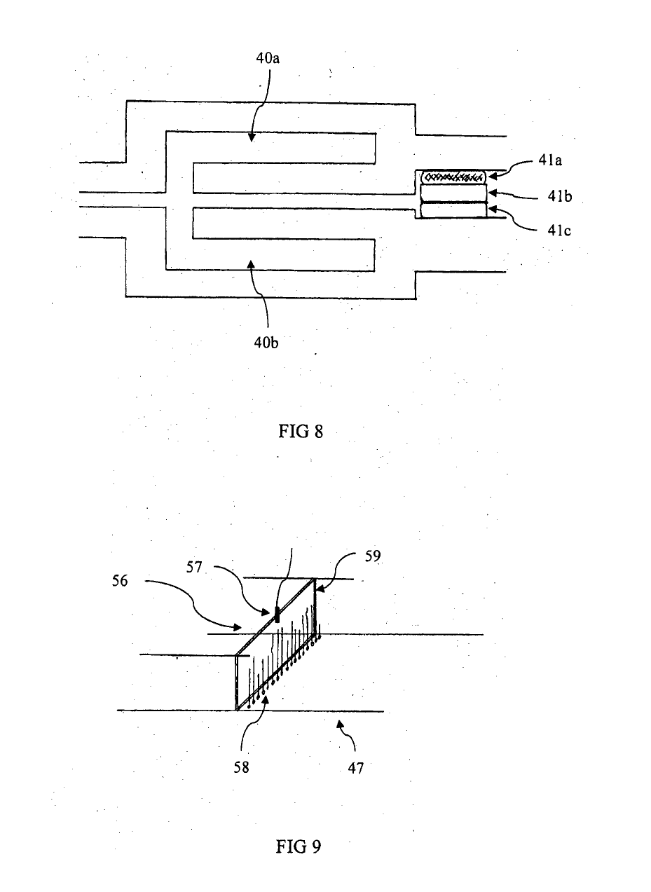

The compartment 4 is also physically and electromagnetically sealed. Microwave chokes 40a, 40b are provided in both the upper stationary portion 30 and the lower rotatable portion 31 to minimise microwave and/or RF wave leakage. To ensure no microwave leakage a second set of chokes can be used or alternatively two metallic discs preferably constructed from copper or brass in contact with each other can be employed to provide a barrier for microwave leakage. This is shown in FIG. 8. The top disc 41b is connected to the upper stationary portion 30 by a fine copper braded connector 41a. The brade applies a slight downwards pressure from the top disc 41b onto the lower rotating disc 41c. The lower disc is connected to the lower rotatable portion 31. The chokes can be configured horizontally or vertically. Gas seals 42, 43 which are of high temperature resistance are provided to seal the compartment 4 from any gas leaks. Insulation 64 is provided on top of the ledge 60 to thermally seal the compartment 4.

The internal surface of the inner tube 35 is kept clean by a metallic or preferably a ceramic scraper 44. The ceramic scraper 44 comprises a rod which sits against the inner surface of the inner tube 35. As the lower portion 31 rotates in use, the scraper 44 scrapes off material on the inner surface the inner tube 35 as it moves past the scraper. It is advantageous to remove such material from the inner surface of the inner tube 35 as microwaves and/or RF waves may couple to the material, causing “hot spots” to form on the inner tube 35.

The transmission assembly comprises a microwave and/or RF transparent microwave window 56. The window 56 preferably formed of quartz is located between the generator 5 and the compartment to protect the radiation generator from plasmas. The window is gas sealed by a microwave transparent preferably a silicon gas seal placed around the circumference of the window. A plasma detector 57 is positioned close to the waveguide window 56. A gas inlet 58 is located on the opposite side of the waveguide to the plasma detector and close to the window. The gas inlet 58 (as shown in FIG. 9) provides a small continual flow of gas which could be air, nitrogen or inert gas vertically against the microwave window. This may be referred to as an “air curtain”. The flow of gas keeps the window clean and at a stable temperature. If plasmas are formed on or close to the window 56, the plasma detector 57 via a PLC signals the gas inlet 58 to blow a larger amount of gas vertically against the window to extinguish the plasma and thereby prevent damage to the window. If the plasmas are not extinguished after a programmed time the PLC will automatically turn down the generator or generators and provide a further blast of air or inert gas. Once the plasmas have been extinguished the PLC will automatically ramp back up the generator's power. If the plasma again reforms on the window the PLC is programmed to shut down the system. A similar waveguide window and plasma extinguishing system is provided in the first apparatus.

FIG. 5 shows a further embodiment of the second apparatus 11 which is gas sealed for processing hazardous, volatile materials or the use of volatile gas reductants such as hydrogen, hydrogen mixtures, carbon monoxide or hazardous gas mixtures. The apparatus includes a lower housing 66 which is joined to the top inlet housing of the screw conveyor 63. High temperature gas seals 67 are positioned between the lower stationary housing 66 and the rotating housing 62. Gases such as air, an inert gas or nitrogen gas would be used at 58 to flush the apparatuses of volatiles. Temperature control would be via the thermocouples 69 and 70 connected to a PLC to vary the power from the radiation generators. Gas sensors 71a, 71b are positioned throughout the apparatus. The sensors are connected via a PLC to shut down the system in the event of volatile gasses or oxygen entering the lower housing of the apparatus 31 or the waveguides.

Whilst the second apparatus 11 may operate with the same frequencies as the first apparatus 10, it is preferred to operate the second apparatus at lower frequencies such as 915 MHz, 460 MHz and RF frequencies due to the greater material penetration depth at these frequencies. The second apparatus 11 is particularly suitable for operating at high temperatures because the rotation of the lower housing portion 31 of the compartment 4 reduces the heat stress placed on any one side of the compartment.

In an alternative arrangement shown in FIG. 6, the second apparatus is configured with a rotary valve 72 connected to the lower rotating outlet tube to meter the material from the apparatus. The rotary valve is driven by a low voltage electric motor 73 and power to the motor is provided through circular electric contact discs 74 connected and insulated to the lower rotating outlet tube and stationary electrical contacts 75.

In another alternative arrangement to that shown in the Figures, the second apparatus is configured such that instead of rotating a portion of the compartment, the waveguide (and radiation generator) is orbited about the compartment such that the material is spiralled through the compartment relative to the electromagnetic radiation being admitted into the compartment.

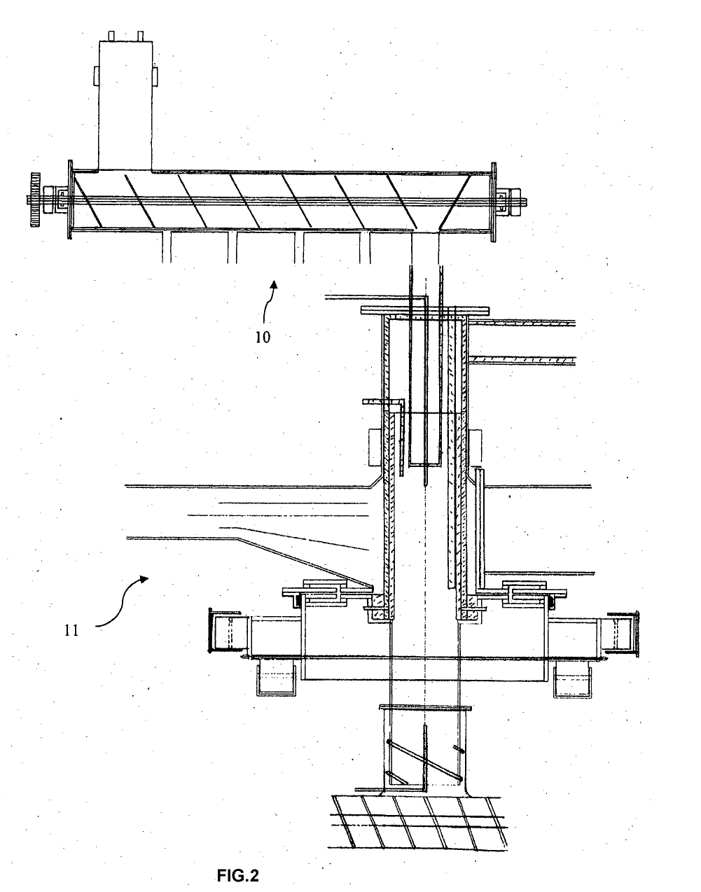

Referring now to FIGS. 1 and 2, a system 100 for continuous microwave and/or RF wave processing of material according to an embodiment of the present invention is shown. The system 100 incorporates the first apparatus 10 and the second apparatus 11. As depicted in more detail in FIG. 2, the first and second apparatuses are arranged in series. It is to be noted that the system 100 may comprise only one of the apparatuses or may comprise more than two apparatuses arranged in parallel or series. Furthermore, although the system is shown having apparatuses of different embodiments of the present invention, both apparatuses could be substantially similar.

However, it is particularly advantageous to have the system shown in FIG. 1 in which the first apparatus 10 feeds to the second apparatus 11. This is because the first apparatus 10 is suitable for operating at high frequencies but low temperatures and with finer temperature control along the length of the compartment 3 whilst the second apparatus is suitable for operating at high temperatures but low frequencies. The first apparatus 10 thus acts as both a “pre-heater” and initial microwave coupler for the second apparatus 11 such that the material fed to the second apparatus 11 from the first apparatus 10 is of sufficient temperature that it can be processed by lower frequency microwaves. At the same time, the second apparatus 11 enables the material to be heated to a sufficient temperature to carry out the required processing which may not be achievable in the first apparatus 10 of itself. Having the first apparatus or multiple first apparatuses in series allows for the material temperature to be gradually increased within the allowable range of the operating thermal shock parameters of the material from which the apparatuses are constructed.

The system 100 also comprises a feed hopper 1 which feeds material to the compartment 3 of the first apparatus 10 via a feed conveyor 2. The feed hopper is preferably heated by gas or waste heat. It is particularly useful to preheat materials in the hopper 1 that do not readily heat with microwaves and/or RF waves. In another embodiment for processing such materials, an aggregate of semi- conductive material which readily couples with microwaves and/or RF waves and subsequently have a high loss of energy may be homogenously mixed with the feed material. The aggregate may be a ceramic such as silicon carbide or zirconia. Such materials are often termed “lossy”. Because they have a high loss of energy after coupling with the microwaves and/or RF waves, they generate convection and radiant heat which heats the surrounding material which it is desired to process. Once the temperature of the material to be processed is increased the microwave and/or RF wave coupling with this material generally increases. The use of a ‘heating’ aggregate provides a more uniform method of preheating material than gas or waste heating of the feed hopper. The aggregate also aids in removing build up off the inner walls of the compartments 3, 4. The aggregate can be screened out of the processed material which exits the apparatuses 10, 11 and reused.

The material being processed feeds from the compartment 3 of the first apparatus 10 into the compartment 4 of the second apparatus 11. The microwave and/or RF generators 5 provide electro-magnetic radiation through waveguides 6, 47 and 49. Fume is removed from the apparatuses 3, 4 via ducting 7. The fume is cooled and collected by any suitable mechanism 8 such as a bag-house, wet scrubber, quick quench tower, splash condenser, distillation column or other similar collection systems. Depending on the application the fume may contain particles of useful product or may be waste. Similarly, the processed material which exits as solid from the system 100 may be waste material or may be a useful product, depending on the application.

### Example I

Electric Arc Furnace (EAF) Dust containing 42% zinc as zinc oxide was thoroughly blended with a reductant of 35% high quality brown coal char containing 94% carbon. The mixed EAF Dust and fine char were pellitized in a pan mixer to 2 to 5 mm pellets. The pelletised material was continuously fed into an apparatus similar to that shown in FIGS. 2-4 and irradiated with microwave electromagnetic energy. In a solid state reaction at 1000° C. zinc fumed from the apparatus and was collected in a baghouse to produce solid zinc oxide particles using each of the different apparatuses.

### Example II

Dry cell batteries including AA and AAA batteries containing zinc as zinc metal, manganese, carbon, plastic and various other minor metals was ground into particles having a diameter of less than 5 mm and thoroughly blended with a reductant of 15% high quality brown coal char containing 94% carbon. The blended material was continuously fed into an apparatus similar to that shown in FIG. 4 and irradiated with microwave electromagnetic energy. At 1000° C. pyrolysis and gasification occurred to the plastic battery wrappings. In a solid state reaction, at 1100° C., zinc fumed from the apparatus. The gas stream was quick quenched by a quick quench tower to minimise the formation of dioxins. After passing through the quick quench tower, the gasses were passed through a catalytic column to completely remove any remaining dioxins from the gas stream.

### Example III

Bag house dust from a steel mill furnace containing 60% iron oxide and 20% carbon were thoroughly blended with a reductant of 25% high quality brown coal char containing 94% carbon. The mixed bag house dust and fine char were pelletized in a pan mixer to 2 to 5 mm pellets. The pelletised material was continuously fed into an apparatus similar to that shown in FIG. 2 and irradiated with microwave electromagnetic energy. At 1000° C. the iron oxide was metalized.

### Example IV

Iron ore fines containing 60% iron oxide were thoroughly blended with a reductant of 40% high quality brown coal char containing 94% carbon. The mixed iron ore fines and fine char were pelletized in a pan mixer to 2 to 5 mm pellets. The pelletised material was continuously fed into an apparatus similar to that shown in FIG. 4 and irradiated with microwave electromagnetic energy. At 1000° C. the iron oxide was metalized.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An apparatus for processing of material, the apparatus comprising:
a compartment for accommodating said material during processing, said compartment having at least one wall, an inlet for receiving the material to be processed and an outlet for material once processed to exit the compartment; and
a radiation source for directing electromagnetic radiation into the compartment through a portion of the compartment wall that is at least partially transparent to the radiation, the radiation being microwave or radio frequency (RF) electromagnetic radiation;
wherein the apparatus is configured to place at least some of the material in the compartment in contact with the at least partially transparent portion of the compartment wall through which the radiation is admitted to the compartment.

2. An apparatus according to claim 1, wherein the radiation source comprises a transmission assembly for transmitting the electromagnetic radiation into the compartment.

3. An apparatus for processing of material, the apparatus comprising:
a compartment for accommodating said material during processing, said compartment having at least one wall, an inlet for receiving the material to be processed and an outlet for the material once processed to exit the compartment; and
a transmission assembly for transmitting microwave or RF electromagnetic radiation to an interior zone adjacent to the compartment wall,
wherein the apparatus is configured such that during operation at least some of the material in the interior zone is in contact with the compartment wall and thereby provides a non-gaseous medium through which the radiation travels upon entry to the interior zone.

4. An apparatus according to claims 2 or 3, wherein the transmission assembly comprises a waveguide.

5. An apparatus according to claim 4, wherein the waveguide has an outlet adjacent the compartment wall.

6. An apparatus according to claims 4 or 5, wherein the transmission assembly comprises a second waveguide cross-coupled to the compartment with respect to the first mentioned waveguide.

7. An apparatus according to any one of claims 4-6, wherein each waveguide is split into a plurality of waveguide paths.

8. An apparatus according to any one of claims 4-7, wherein each waveguide is a TE10 mode waveguide.

9. An apparatus according to any one of claims 4-98, wherein the compartment is of substantially the same width as the waveguide.

10. An apparatus according to any one of claims 2-9, wherein the apparatus also comprises at least one radiation generator for generating microwave and/or RF electromagnetic radiation, the transmission assembly being configured to transmit the radiation generated by each generator to the compartment.

11. An apparatus according to claim 10, wherein the transmission assembly comprises a waveguide window for protecting the radiation generator from plasmas.

12. An apparatus according to claim 11, wherein the transmission assembly comprises a waveguide window shielder configured to blow a layer of gas over the surface of the window.

13. An apparatus according to claims 11 or 12, wherein the transmission assembly comprises a plasma extinguishing system for extinguishing plasmas close to the waveguide window.

14. An apparatus according to claim 13, wherein the plasma extinguishing system comprises one or more gas inlets configured to blow gas into the waveguide to extinguish any plasmas.

15. An apparatus according to any one of the preceding claims, wherein the apparatus is of TE10 dominant mode design.

16. An apparatus according to any one of the preceding claims, wherein the compartment has a single cylindrical wall.

17. An apparatus according to any one of the preceding claims, wherein at least a part of the compartment is configured to rotate about a central longitudinal axis.

18. An apparatus according to any one of the preceding claims, wherein the apparatus comprises a casing around the compartment and at least a part of the compartment is configured to rotate within the casing.

19. An apparatus according to claim 18, wherein the transmission assembly extends through the casing.

20. An apparatus according to any one of the preceding claims, wherein the apparatus comprises a mechanism for causing the material to travel in a spiral flow path relative to the direction of the electromagnetic radiation admitted into the compartment as the material travels between the inlet and the outlet.

21. An apparatus according to claim 20, wherein the spiralling mechanism comprises a rotating screw located inside the compartment.

22. An apparatus according to claim 21, wherein the axis of the rotating screw is coaxial with a longitudinal axis of the compartment.

23. An apparatus according to claim 20 or 21, wherein the flights of the screw extend between the longitudinal inner surfaces of the compartment.

24. An apparatus according to any one of the preceding claims, wherein the apparatus is configured so that the operating height of the material in the compartment is above the portion of the compartment wall through which the electromagnetic radiation is admitted.

25. An apparatus according to any one of the preceding claims, wherein the inlet and the outlet of the compartment define a general direction of flow of the material through the compartment including past the portion of the compartment wall through which the electromagnetic radiation is admitted and wherein the apparatus is configured so that the electromagnetic radiation is admitted into the compartment transverse to this general direction of flow.

26. An apparatus according to any one of the preceding claims, wherein the apparatus comprises a gas outlet for gas to exit the compartment.

27. An apparatus according to claim 26, wherein the gas outlet is located above the operating height of the material.

28. An apparatus according to any one of the preceding claims, wherein the apparatus comprises a plurality of temperature sensors located along the length of the compartment.

29. An apparatus according to any one of the preceding claims, wherein the apparatus comprises a first temperature sensor capable of sensing the temperature in an internal portion of the compartment and a second temperature sensor capable of sensing the temperature near the inner surface of the compartment wall.

30. An apparatus according to claim 29, wherein the first temperature sensor is located in the internal portion of the compartment.

31. An apparatus according to any one of claims 28-30, wherein each temperature sensor is provided with a microwave or RF electromagnetic radiation reflective sheath.

32. An apparatus according to claim 31, wherein each sheath is earthed.

33. An apparatus according to any one of the preceding claims, wherein the apparatus also comprises a scraper for scraping material off the inner surface of the compartment wall.

34. An apparatus according to claim 33, wherein the scraper comprises a rod sitting against the inner surface of the compartment wall.

35. An apparatus according to claim 33 or 34, wherein the scraper extends substantially the length of the compartment.

36. A system for processing of material, the system comprising at least two apparatuses for processing of material as claimed in any one of preceding claims.

37. A method of processing material, the method comprising:
receiving the material to be processed in a compartment through an inlet of the compartment, the compartment having at least one wall;
emitting electromagnetic radiation from a radiation source into the compartment through a portion of the compartment wall which is at least partially transparent to radiation, the radiation being microwave or radio frequency (RF) electromagnetic radiation;
contacting at least some of the material to be processed with the portion of the compartment wall through which radiation is admitted into the compartment, prior to admitting the radiation into the compartment; and
outputting the material once processed through an outlet of the compartment.

38. A method according to claim 37 also comprising flowing the material between the inlet and the outlet of the compartment in a spiral flow path relative to the direction of the electromagnetic radiation admitted into the compartment.

39. A method according to claim 37 or 38, the method also comprising rotating the compartment as the radiation is being admitted into the compartment.

40. A method according to any one of claims 37-39, the method also comprising outputting gasses from the compartment through a gas outlet located above the height of the material in the compartment.
